(19) United States
(12) Patent Application Publication
(10) Pub. No.: US 2006/0006635 A1
(43) Pub. Date: Jan. 12, 2006

(54) DEVICE FOR USE WITH LIQUID CONTAINER FOR A VEHICLE AND METHOD FOR MOUNTING SAID LIQUID CONTAINER

(75) Inventor: Sigurd SONDEREGGER, Askim (SE)

Correspondence Address: NOVAK DRUCE & QUIGG, LLP, 1300 EYE STREET NW, 400 EAST TOWER, WASHINGTON, DC, 20005, US

(73) Assignee: VOLVO LASTVAGNAR AB, Goteborg (SE)

(21) Appl. No.: 11/162,752

(22) Filed: Sep. 21, 2005

Related U.S. Application Data
(63) Continuation of application No. PCT/SE04/00119, filed on Jan. 30, 2004.

(30) Foreign Application Priority Data
Mar. 21, 2003 (SE) 0300813-3

(51) Int. Cl. B60P 3/22

(52) U.S. Cl. 280/830

(57) ABSTRACT

Method and device for use with a liquid tank for a vehicle including a tank (1) of at least a part-circular cross section and one or more bearing brackets (3), cooperating with a flexible clamping element (15), for fastening the tank (1) to the vehicle. The bearing bracket(s) (3), viewed in a transversely directed plane relative to the longitudinal direction of the liquid tank (1), are configured as a substantially vertical cradle, having a web (21) extending in the vertical direction and having a support surface (4) for cooperation with the part-circular cross section of the tank (1). The tank (1) is provided with at least one locating member (31) for cooperation with at least one of the bearing brackets (3), which locating members are constituted by projections (33) designed to position and detain the tank (1) on the bearing brackets (3) prior to the fastening of the clamping element (15).

### CROSS-REFERENCE TO RELATED APPLICATIONS

The present application is a continuation patent application of International Application No. PCT/SE2004/000119 filed 30 Jan. 2004 which was published in English pursuant to Article 21(2) of the Patent Cooperation Treaty, and which claims priority to Swedish Application No. 0300813-3 filed 21 Mar. 2003. Said applications are expressly incorporated herein by reference in their entireties.

### TECHNICAL FIELD

The present invention relates to a device for use with a liquid tank for a vehicle, more precisely to a device for supporting and securing the tank on the vehicle in the form of at least one bearing bracket fixed to the vehicle, and which is provided with members for securing the tank to the bearing bracket, and to a tank having locating members for facilitating mounting and fixing of the tank to the bracket.

### BACKGROUND OF THE INVENTION

Liquid tanks for heavy vehicles, especially fuel tanks and the like for heavy goods vehicles, are usually configured in substantially cylindrical form with two end faces and an intermediate shell surface. There are two main types of tanks available on the market, one of which is circular-cylindrical, hereinafter referred to as a circular tank—and the other of which is rectangular-cylindrical—hereinafter referred to as a rectangular tank.

Until now the most widely adopted solution for supporting a tank, especially for heavy vehicles, is to utilize an L-shaped bearing bracket, which reaches in beneath the tank and cooperates with straps that are fastened at the outer ends of the bearing bracket and which, together with the bracket, embrace the tank for its securement to the bracket. The tank is in this case usually rectangular, with corner portions that are somewhat rounded. In this type of bearing bracket, the part reaching in beneath the tank requires space in the vertical direction, which means that the total space for the tank and bracket cannot be utilized effectively for the storage of liquid, since the ground clearance requirement limits the space downward. One advantage with the rectangular tank is that, precisely by virtue of its rectangular shape, it has no tendency to rotate in its fastening during travel.

Circular tanks are also available, which have the drawback that they offer a smaller cubage (volume) and run the risk of rotating in their fastening, which generates stresses upon the tank fittings, i.e. their connecting elements for connecting pipes. Because of their circular shape, these tanks require no special positioning when mounted onto the vehicle, since they can easily be turned into the correct position before being clamped in place.

One advantage of circular tanks is the round tank bottom shape which has a minimal residual cubage; i.e. the volume which can never be drawn out of the tank as a result of the suction tube of the tank being located, by necessity, at a certain distance from the tank bottom. A further advantage with the circular tank is that it is fastened to the vehicle frame by two relatively compact—and hence weight-saving—bearing brackets, which, moreover, offer good ground clearance by virtue of being designed as a vertical cradle having an, in principle, part-circular bearing surface for the tank. The bearing brackets are provided with fixtures for straps by which the circular tank is forced in against the cradles of the bearing brackets.

A further solution is constituted by an asymmetrical, for example D-shaped tank, in which the part of the tank which bears against a bracket fixed to the vehicle has a cylindrical, oval or similar rounded shape. These embodiments are referred to as “part-circular” in the description(s) below. Such a tank is able to combine the advantages of the abovementioned tank types. Owing to its extent transversely to the longitudinal axis of the vehicle, the tank must, however, be accurately positioned when mounted and must be clamped in place such that it cannot be turned or rotated in any direction since a small turn in connection with the bracket can produce a relatively large displacement of the outer end of the tank.

The present invention aims to produce improved fastening for the abovementioned tank types when provided with a part-circular bearing surface, and by which also simplifies mounting and fixing the tank to a bracket on a vehicle.

### SUMMARY OF THE INVENTION

An object of the present invention is to produce a device for use with a liquid tank and by which the available space is maximally utilized for the storage of liquid. The liquid tank is able to be easily mounted and subsequently held securely fixed in a chosen position. The tank is preferably intended for some form of propellant for the vehicle engine or an auxiliary engine, urea for the after-treatment of exhaust gases, water and other types of liquid.

The invention therefore relates to a liquid tank for a heavy vehicle, suitable for fastening to a vehicle frame by at least one bearing bracket having a part-circular bearing surface against the liquid tank. The tank comprises (includes, but is not necessarily limited to) two end face portions and a substantially cylindrical shell portion extending therebetween. The invention is especially characterized by the fact that the tank comprises a first, substantially part-circular portion facing the vehicle frame and which is suitable for bearing contact against the part-circular bearing surface of the bearing bracket and a second, substantially rectangular portion faces away from the vehicle frame. The part-circular portion has been provided with locating members for facilitating mounting and fixing of the tank. Beyond the part-circular bearing surface, the tank can be given any chosen form, having D-shaped or circular cross section, for example.

According to a first embodiment, the invention comprises a device for use with liquid tanks for vehicles having a tank of at least a part-circular cross section and one or more bearing brackets cooperating with a flexible clamping element for fastening the tank to the vehicle. The bearing bracket(s), viewed in a transversely directed plane relative to the longitudinal direction of the liquid tank, is/are configured as a substantially vertical cradle, having a web extending in the vertical direction and having a support surface for cooperation with the part-circular cross section of the tank. The tank is preferably provided with at least one locating member for cooperation with at least one of the bearing brackets, which locating members are constituted by projections designed to position and detain the tank on the bearing brackets prior to the fastening of the clamping element.

The abovementioned projections comprise a first end fixed to the tank and a second end facing the bracket, which second end bears against the bracket on a rear side of the support surface facing away from the tank. The first end of the projection is in this case angled out from the tank and constitutes a stop for positioning of an upper end face of the support surface. The second end of the projection lies preferably, but not necessarily, substantially parallel with the tank.

According to one embodiment, the second end of the projection can be suspended about the upper end face of the support surface.

According to an alternative embodiment, the second end of the projection can be suspended about an end face in a cavity in the support surface.

The projection can also be configured in one piece with a base plate, the bottom surface of which is matched to the cross-sectional profile of the tank. The base plate should in this case have the same part-cylindrical shape as the tank and the support surface. At least a part of the base plate can be designed to bear against the support surface as a result of its placement between the tank and the support surface. This placement helps, firstly, to lock the locating member and, secondly, to stop the tank from moving in its longitudinal direction after mounting and fixing.

According to a further embodiment, a front face on the second end of the projection can diverge from the outer surface of the tank viewed in the direction of the bracket. This arrangement facilitates mounting of the tank, since the front face acts as a guide which makes it easier for the second end of the projection to pass the front edge of the support surface for bearing contact against the rear side of the support surface.

The tank can herein be provided with a locating member, which can be fixed or detachably fastened to the outer boundary surface of the tank in connection with that section which is to bear against the bearing bracket. The locating member is designed to cooperate with the bearing bracket, at least in association with mounting of the tank, for correct location of the latter prior to fixing, and can help to support and prevent the tank from turning after fixing.

The locating members, in the first place, position the tank in the vertical direction, so that the tank ends up in the correct position relative to a horizontal plane. In addition, the locating members can be configured or placed so as to position the tank in a correct position relative to the brackets in the longitudinal direction of the vehicle. According to one embodiment, this can be achieved by giving at least one of the locating members the same width as the front edge of the bracket, between its side faces. According to an alternative embodiment, both the locating members can be placed asymmetrically relative to the respective bracket.

The placement of the locating members on the tank can be chosen such that, upon mounting, they are positioned in connection with the two outer, alternatively inner, side edges of the bracket. With a symmetrical placement of the locating members, the position of the tank can be located by both of the locating members bearing against the front, alternatively the rear, side faces of the respective bracket, viewed in the longitudinal direction of the vehicle. In order to achieve the above-stated positioning effect, at least one of the two brackets is configured with a front edge which is preferably delimited by at least one substantially vertical side face, alternatively by a pair of mutually opposing vertical side faces.

By configuring the locating member in a resilient material and choosing a distance between the second projection and the base plate which is less than the thickness of the bracket in connection with the front edge, the outer end of the second projection can brought to bear against the bracket with a spring force. This arrangement helps, for example, to secure the tank in its intended position and stops the tank from being displaced while straps or the like are fitted around the tank for fixing thereof.

If the locating member is suitably dimensioned, the tank can be positioned and secured with just one such member.

According to a further embodiment, the projection can be integrated with the tank. This can be done in the manufacture of the tank, for example by working of a metallic material, alternatively in association with injection molding of a plastics tank.

According to a further embodiment, the projection can be fixed to the tank after manufacture, but before mounting. The fastening can be realized by means of glue, which is applied to the locating member by coating or by means of a double-sided adhesive tape. The projection can also be fastened by means of welding.

The invention also relates to a method for mounting a liquid tank for a vehicle, in which a tank of at least part-circular cross section and one or more flexible clamping elements cooperate with bearing brackets for fastening the tank to the vehicle. The bearing bracket(s), viewed in a transversely directed plane relative to the longitudinal direction of the liquid tank, is/are configured as a substantially vertical cradle, having a web extending in the vertical direction and having a support surface for cooperation with the part-circular cross section of the tank. The mounting is effected by: (i) the tank, which is provided with at least one locating member in the form of a projection for cooperation with at least one of the bearing brackets, being lifted into bearing contact against the bearing brackets; (ii) the tank being turned about its longitudinal axis along the support surfaces until the projection engages with corresponding bearing brackets so as to position the tank in a predetermined position; and (iii) the projection detaining the tank on the bearing brackets while the clamping element is fastened and tightened.

The invention also makes it possible to use similar bearing brackets on all vehicles, regardless of whether these are intended for markets in which traditionally either circular or rectangular ones are demanded. The design and production costs for the manufacturer can thereby be substantially reduced.

### BRIEF DESCRIPTION OF THE DRAWINGS

The invention will be described in greater detail below by way of an illustrative embodiment with reference to the appended diagrammatic drawing figures, in which:

FIG. 1 is a perspective view showing a tank configured according to the present invention and provided with bearing bracket and straps;

FIG. 2 is an end view of the liquid tank of FIG. 1, and in which the tank is shown fastened by means of bearing brackets and straps to a vehicle frame;

FIG. 3 is a diagrammatic, comparative tank profile view in which the differences in cubage between a circular tank, a substantially rectangular tank and the tank of FIG. 1 are depicted;

FIG. 4 is a perspective view of a fastening device for a strap for clamping the tank to a bearing bracket;

FIG. 5 is a cross-sectional view showing the fastening device of FIG. 4;

FIG. 6 is a perspective view showing a fastening device and a locating member configured according to one embodiment of the invention; and

FIG. 7 is a perspective view showing a locating member configured according to one embodiment of the invention.

### PREFERRED EMBODIMENTS

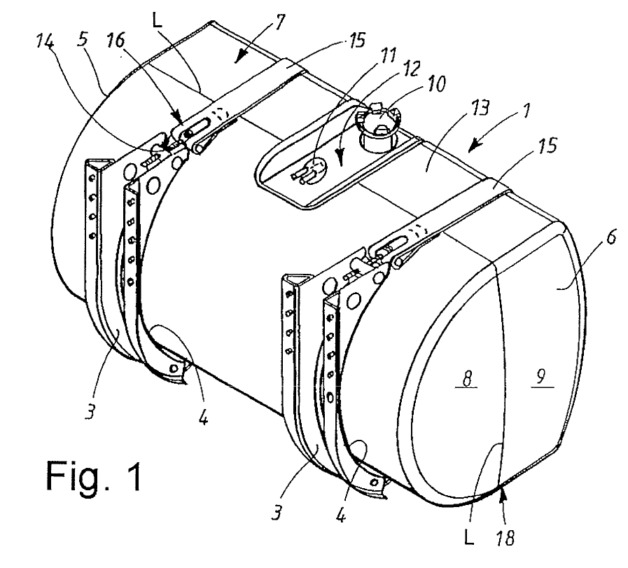

In FIG. 1, the reference numeral 1 denotes in general terms a liquid tank according to the invention. The liquid tank 1 is constituted mainly by two end face portions 5, 6 and a substantially cylindrical shell portion 7 extending therebetween. A filler cap 10 and a tank fitting 11, provided with, inter alia, the liquid line from the tank (not shown), are placed in a recess 12 on the top side 13 of the tank 1. As a result of the recess 12, the filler cap 10 and the tank fitting 11 are positioned such that they only marginally jut up over the top side 13 of the tank and are thus well protected against mechanical damage from, for example, a vehicle chassis (not shown), which swings past directly above the top side.

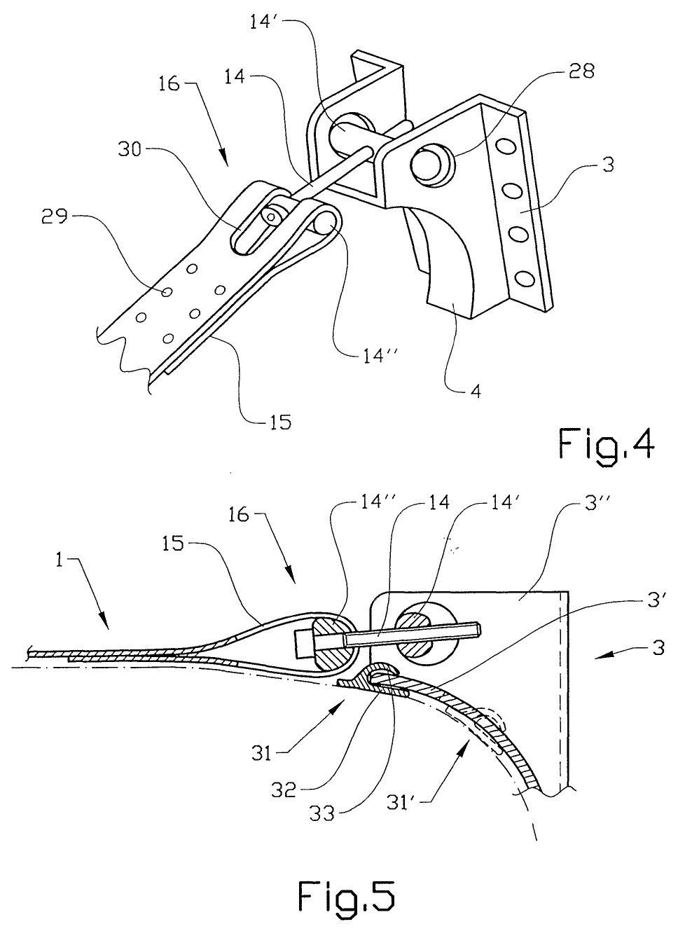

As can clearly be seen from FIG. 1, the tank 1 is intended, in a known manner, to be fastened to a vehicle frame 2 by two bearing brackets 3, which are mounted on the vehicle frame by means of bolt joints 17. The bearing brackets 3 are further provided, in a known manner, with fixtures for straps 15 provided with clamping devices 16 (see FIGS. 4 & 5), with the aid of which the tank 1 is forced in against part-circular bearing surfaces 4 on the bearing brackets. The tank 1 is normally made of steel plating but can also be made of other materials suitable for the purpose, such as aluminum or a suitable plastics or composite material.

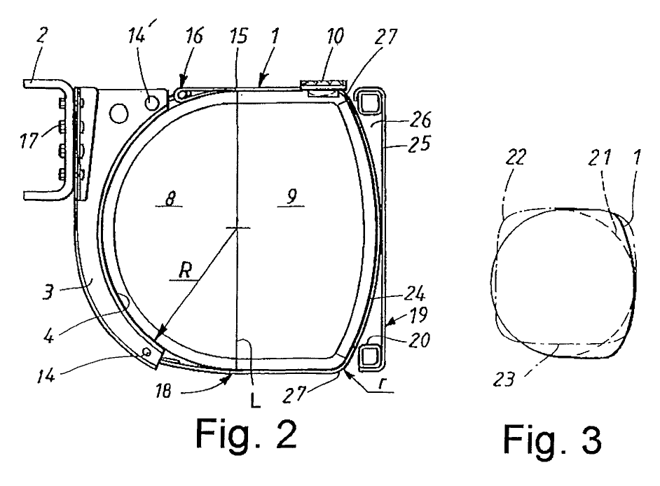

The tank 1 according to the invention is characterized in that its shell portion 7 comprises a first, substantially part-circular portion 8 facing the vehicle frame 2 and suitable for bearing contact against the part-circular bearing surface 4 of the bearing bracket 3, and a second, substantially rectangular portion 9 facing away from the vehicle frame 2. In FIG. 1 and FIG. 2, a dividing line L has been drawn in, for the sake of clarity, between the part-circular portion and the rectangular portion, which dividing line is not, however, present on the actual tank. By the term part-circular portion should here be understood a portion of the tank which in profile—viewed from the end face portions 5, 6 of the tank—has the shape of a sector of a circle, yet not a whole circle. In the preferred embodiment which is illustrated in the figures, this part-circular portion 8 is semicircular. This gives the great advantage that the tank 1 can be fastened with the aid of bearing brackets of the well-known type which have long been used for fastening circular liquid tanks. As a result of the special configuration of the tank, a tank bottom is additionally obtained—denoted in general terms by the reference numeral 18—which offers a severely reduced residual cubage compared with a traditional rectangular tank, i.e. the cubage which can never be drawn out of the tank as a result of the liquid suction tube (not shown) of the tank 1 being located, by necessity, at a certain distance from the tank bottom 18. FIG. 2 also shows a so-called chassis skirt 19, which is situated closely adjacent to the outer side 24 of the tank 1. The chassis skirt 19 is constituted by substantially vertical plastics panels 25, which extend along the sides of the vehicle and are supported by a framework 20, which is fastened in the vehicle frame 2 with the aid of brackets (not shown). It can be seen from the figure that the outer side 24 of the tank 1, which constitutes a side of the abovementioned rectangular portion 9, is arched slightly outward, i.e. in the direction away from the vehicle frame 2, in such a way that it projects into the framework 20 with a view to utilizing an existing space 26 within the framework 20 for liquid cubic capacity. The tank 1 is prevented from rotating in its fastening during vehicle travel by the fact that the rectangular portion 9 has, relative to the part-circular portion 8, sharp corners 27, around which the straps 15 are forcibly bent into formal bearing contact by means of the clamping devices 16. As can be seen from FIG. 2, these corners 27 are situated at the bottom edge and top edge, respectively, of the outer side 24 of the tank 1. The corners 27 in this case have radii of curvature, denoted by “r” in FIG. 2, which are at least 5 times smaller than the radius of curvature, denoted by “R” in the same figure, of the part-circular portion 8. Preferably, the radii of curvature r of the corners 27 are approximately seven times smaller than the radius of curvature R of the part-circular portion 8.

FIG. 3 shows diagrammatically, in profile, the difference in liquid cubic capacity between the tank form according to the invention and the two known tank forms in directly comparable proportions and with the relative positions which the liquid tanks would have if mounted in the same vehicle application. The tank according to the invention is denoted, as previously, by the reference numeral 1 and is shown by a continuous line, whereas a circular tank 21 is shown by a dashed line and a rectangular tank 22 is shown by a dash-dot line. It can be seen from the figure that the bottom 23 of the rectangular tank is placed higher than in the two other tanks. As previously mentioned, the reason for this is that space is stolen in the downward direction by the L-shaped bearing bracket (not shown) required to fasten the rectangular tank 22. If a rectangular tank 22 of the illustrated, traditional type is used, liquid cubic capacity is therefore sacrificed in order to maintain a given ground clearance. It can further clearly be seen that the liquid tank 1 according to the invention has a larger liquid cubic capacity than the traditional tank. Compared with the circular tank 21, the tank 1 according to the invention has 9% greater cubage and, compared with the rectangular tank, the tank 1 according to the invention has 2% greater cubage. The rectangular tank 22 has, however, a greater residual cubage than the tank 1, so that the difference in usable liquid cubic capacity is, in practice, around 4-5%.

Even though the bracket essentially should not jut up or down beyond the horizontal limit plane of the tank, the bracket can nevertheless, within the scope of the invention, project slightly, such as by around 1-4% of the height measurement, i.e. vertical dimension, of the tank. The clamping device does not have to be placed at the end of the strap, but can alternatively be placed at a distance from the fastening point of the strap, for example in the middle of the strap.

FIG. 4 shows a perspective view of a possible fastening device 16 for a strap 15 for clamping the tank 1 to a bearing bracket 3. The fastening device 16 comprises a screw 14, the threaded end of which is fastened in a threaded hole in a first cylindrical body 14′ placed with its longitudinal direction transversely to the longitudinal axis of the screw. The cylindrical body 14′ is mounted with its ends in a pair of mutually opposing cavities 28 at the upper end of the bracket 3. The head of the screw 14 bears against a corresponding second cylindrical body 14″ provided with a bored hole through which the screw 14 passes. The end of the strap 15 has been curved round into a loop and is fastened together by a number of spot welds 29. The loop has been provided with a continuous central slot 30, the second cylindrical body 14″ being placed in the loop. The slot 30 allows, firstly, that the screw 14 can reach the first cylindrical body 14′ and, secondly, that the screw head can be accessed by a tightening tool.

FIG. 5 shows a cross section through a fastening device 16 and a bearing bracket 3. The tank 1 is indicated by dashed lines in FIG. 5. In order to locate the tank 1 relative to the bracket 3 during mounting, the tank 1 is provided with a locating member 31 fixed to the tank 1. The locating member 31 comprises a base plate 32 provided with a clasp 33 cooperating with the bearing bracket. That part of the base plate 32 which faces the bearing bracket is situated beneath an outer edge of that section 3′ of the bearing bracket which imitates the shape of the tank. This outer edge preferably constitutes an end face, terminating the first section 3′, at right angles to a plane through the principal longitudinal extent of the support surface 4. The first section 3′ binds together a pair of vertical second sections 3″ of the bearing bracket, which vertical sections comprise the cavities 28 in which the abovementioned cylindrical body 14′ is mounted. That part of the clasp 33 which faces the bearing bracket 3 bears against the top surface of the first section 3′.

An alternative embodiment is indicated by dashed lines in FIG. 5. According to this embodiment, the support surface 4 is provided with a cavity through which a locating member 31′ can be guided, the tank being rotated along the support surface into its desired position. The mounting of the tank is described more extensively below.

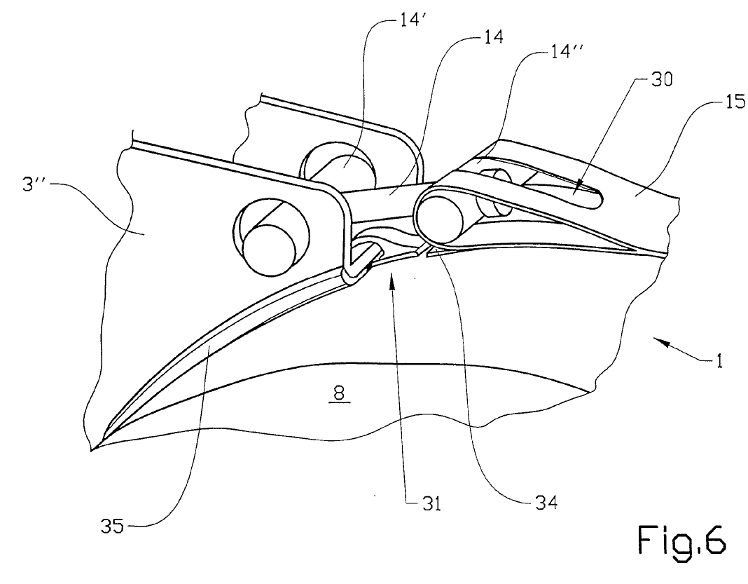

FIG. 6 shows a perspective view of the fastening member 16 and the locating member 33 with the tank 1 mounted on the vehicle. As can be seen from the figure, a respective liner 34 and 35 is placed between the bearing bracket 3 and strap 15, respectively, and the tank in order to dampen vibrations and minimize wear between the various component parts. This liner is preferably made of rubber or a suitable elastomer material.

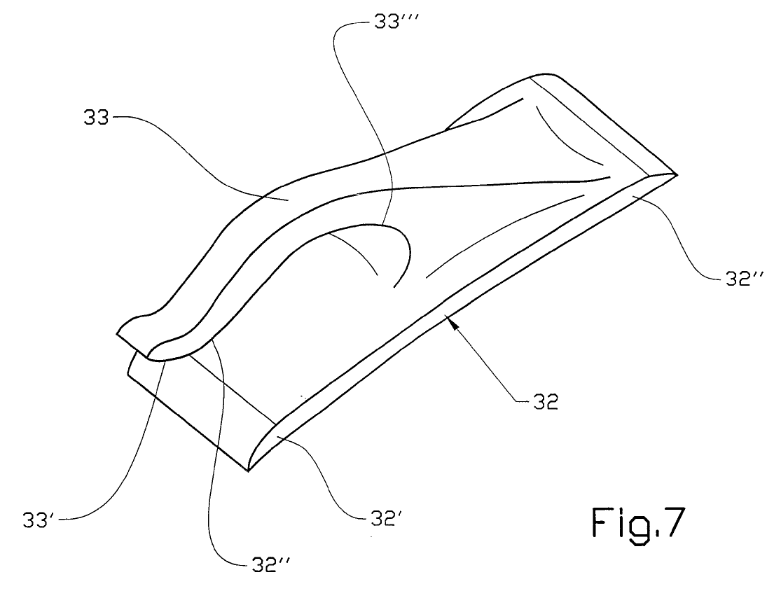

FIG. 7 shows an embodiment of the locating member 31 according to the invention. As indicated above, the locating member comprises a base plate 32, intended for fastening to the tank, and a clasp 33, cooperating with the bearing bracket. The embodiment shown in FIG. 7 is produced in a plastics material by means of injection molding. Examples of plastics materials suitable for this purpose are polyethylene, polypropylene or polyamide. Preferably, glass fiber is used to reinforce the material. The clasp is preferably somewhat resilient. The front edge 32′ of the base plate, facing the bearing bracket, is beveled, preferably with a somewhat rounded bevel, so as to produce a smooth transition to the tank. This configuration makes it easier for the base plate 32 to slide in beneath the outer edge of the bearing bracket during mounting. Correspondingly, the rear edge 32″ of the base plate is also beveled. This facilitates possible cooperation with the liners 35 and loops of the straps, should these come into contact with the base plate as the screw 14 of the fastening device 16 is tightened.

The clasp 33 extending forward from the rear section of the base plate 32 is provided with a front section 33′ equipped with a surface angled forward and upward relative to the base plate 32. The distance between the top surface of the base plate 32 and the bottom surface of the front section 33′ on the end of the clasp 33, in a direction perpendicular to the plane of the base plate at the respective measuring point, is in this case somewhat greater than the combined thickness of the outer edge of the bearing bracket 3 and its associated liner 34. The clasp also comprises an intermediate section 33″ placed between the front section 33′ of the clasp, which diverges from the base plate 32, and the main part of the clasp. The distance between the bottom surface of the intermediate section 33″ and the top surface of the base plate is somewhat less than the combined thickness of the outer edge of the bearing bracket 3 and its associated liner 34. From this intermediate section, the bottom surface of the clasp diverges back in the direction away from the base plate, finally to curve downward toward and meet this. This inner curved section 33′″ constitutes a stop for the outer edge of the bearing bracket 3 in association with mounting of the tank.

The front section 33′ of the clasp herein facilitates the mounting of the tank by acting as a guide for the outer edge of the bracket, whilst the intermediate section 33″ forces the resilient clasp up and bears with a certain pressure against the top surface of the first section 3′ of the bearing bracket.

The locating member according to FIG. 7 shows just one preferred embodiment. Both the base plate and the clasp can also be given a narrower or wider shape relative to the longitudinal direction of the clasp. The base plate can also be made shorter so that its front part intrudes a shorter distance beneath the bracket, alternatively is terminated at the outer edge of the bracket without intruding beneath it. The clasp does not need to be configured with a resilient section, but can instead be constituted by a fixed, rigid, alternatively a somewhat deformable clasp. This is the case if the tank and the locating members are made of the same metallic material. The mutual distance between the locating members 31 can be matched to the distances between the vertical side faces 3″ of the brackets 3 so as to locate the tank 1 in the longitudinal direction of the vehicle.

The fastening of the clasp to the tank is dependent on the choice of material for the tank and locating members, respectively. Locating members made of plastics material or metal can preferably be mounted with the aid of glue or double-sided adhesive tape. If the component parts are made of the same or similar materials, they can also be welded together. If locating members and tank are made of different metallic materials, these may need to be isolated from one another in order to avoid galvanic corrosion. The latter also applies to locating members and bearing bracket. For tanks made of plastics material, it is also possible to integrate locating members in one piece with the tank.

In the mounting of the tank 1, the two straps 15 (see FIG. 1) are fixed to the lower section of the bearing bracket. The vibration-damping liners 34 of the two bearing brackets 3 are also, for their part, pre-mounted on the first sections 3′. A tank 1 provided with a pair of pre-mounted locating members 31 is lifted in place, the two members 31 being hooked onto the outer edges of the first sections 3′. The resilient bearing contact of the members 31 against the bracket 3 also allows a simple fit in the lateral direction, i.e. in the longitudinal direction of the tank. The tank 1 is thus placed in the correct position for mounting and is held in this position with the aid of the locating members 31. The straps 15 and associated liners 35 can thereafter be pulled into place around the tank and fixed to the two bearing brackets 3 with the aid of a respective clamping device 16. During running of the vehicle, the two straps and the locating member fixed to the tank stop the tank from turning in any direction.

The invention is not limited to the illustrative embodiments shown above and in the drawings, but can instead be varied within the scope of the following patent claims. For example, the two illustrated bearing brackets can be replaced by a single wide bracket or a larger number of brackets, depending on the extent of the tank in the longitudinal direction. The fastening of the strap can be released differently. The strap can further be replaced by some other clamping element, such as wire, cable, chain or the like. The brackets can be given a number of alternative profile forms which offer a fastening surface against the vehicle and a form-locking support surface against the tank, and also a support surface which can imitate a tank of non-circular cross sectional shape so that it combats rotation. The embodiment indicated in connection with FIGS. 1-7 describes a so-called D-shaped tank of part-circular section. The invention can also be applied, however, to tanks of cylindrical, oval and rectangular basic form.

What is claimed is:

1. A device for use with a liquid tank for a vehicle, comprising:
a tank (1) of at least a part-circular cross section and one or more bearing brackets (3), cooperating with a flexible clamping element (15), for fastening the tank (1) to the vehicle, said bearing bracket(s) (3), viewed in a transversely directed plane relative to the longitudinal direction of the liquid tank (1), being configured as a substantially vertical cradle, having a web extending in the vertical direction and having a support surface (4) for cooperation with said part-circular cross section of the tank (1), wherein the tank (1) is provided with at least one locating member for cooperation with at least one of said bearing brackets (3), which locating members are constituted by projections (31) designed to position and detain the tank (1) on said bearing brackets (3) prior to the fastening of said clamping element (15).

2. The device as recited in claim 1, wherein said projections (31) comprise a first end (32, 33′″) fixed to the tank (1) and a second end (33) facing the bracket, which second end bears against the bracket on a rear side of the support surface (4) facing away from the tank (1).

3. The device as recited in claim 2, wherein said first end (33′″) of the projection (31) is angled out from the tank (1) and constitutes a stop for positioning of an upper end face of the support surface (4).

4. The device as recited in claim 3, wherein said second end of the projection (31) lies substantially parallel with the tank (1).

5. The device as recited in claim 4, wherein said projection (31) is fastened to or integrated with the tank (1).

6. The device as recited in claim 4, wherein said second end of the projection (31) is suspended about the upper end face of the support surface (4).

7. The device as recited in claim 4, wherein said second end of the projection (31′) is suspended about an end face in a cavity in the support surface (4).

8. The device as recited in claim 4, wherein said projection (31) is configured in one piece with a base plate (32), the bottom surface of which is matched to the cross-sectional profile of the tank (1).

9. The device as recited in claim 4, wherein at least a part of the base plate (32) is designed to bear against the support surface (4).

10. The device as recited in claim 4, wherein a front face on the second end (33″) of the projection (31) diverges from the outer surface of the tank (1) in the direction of the bracket (3) and bears against the bracket with a spring force.

11. The device as recited in claim 1, wherein at least one locating member is designed to bear against at least one vertical side face of the bracket.

12. A device for use with a liquid tank for a vehicle, comprising:
a tank (1) of at least a part-circular cross section and having at least one bearing bracket (3) that cooperates with a flexible clamping element (15), for fastening the tank (1) to the vehicle;
said at least one bearing bracket (3), viewed in a transversely directed plane relative to a longitudinal direction of the liquid tank (1), configured as a substantially vertical cradle having a web extending in the vertical direction and having a support surface (4) for cooperation with said part-circular cross section of the tank (1); and
said tank (1) having at least one locating member configured to cooperate with at least one of said bearing brackets (3), said locating members comprising projections (31) configured to position and retain the tank (1) on said bearing brackets (3) prior to the fastening of said clamping element (15).

13. The device as recited in claim 12, wherein said projections (31) comprise a first end (32, 33′″) fixed to the tank (1) and a second end (33) facing the bracket, which second end bears against the bracket on a rear side of the support surface (4) facing away from the tank (1).

14. The device as recited in claim 13, wherein said first end (33′″) of the projection (31) is angled out from the tank (1) and constitutes a stop for positioning of an upper end face of the support surface (4).

15. The device as recited in claim 14, wherein said second end of the projection (31) lies substantially parallel with the tank (1).

16. The device as recited in claim 15, wherein said projection (31) is fastened to or integrated with the tank (1).

17. The device as recited in claim 15, wherein said second end of the projection (31) is suspended about the upper end face of the support surface (4).

18. The device as recited in claim 15, wherein said second end of the projection (31′) is suspended about an end face in a cavity in the support surface (4).

19. The device as recited in claim 15, wherein said projection (31) is configured in one piece with a base plate (32), the bottom surface of which is matched to the cross-sectional profile of the tank (1).

20. A method for mounting a liquid tank for a vehicle, said method comprising:
providing a tank (1) of at least part-circular cross section and one or more bearing brackets (3), cooperating with a flexible clamping element (15), for fastening the tank (1) to the vehicle, said bearing bracket(s) (3), viewed in a transversely directed plane relative to the longitudinal direction of the liquid tank (1), being configured as a substantially vertical cradle, having a web extending in the vertical direction and having a support surface (4) for cooperation with said part-circular cross section of the tank (1), wherein the tank (1) is mounted by: (i) the tank (1), which is provided with at least one locating member in the form of a projection (31) for cooperation with at least one of said bearing brackets (3), being lifted into bearing contact against the bearing brackets; (ii) the tank (1) being turned about its longitudinal axis along said support surfaces until said projection (31) engages with corresponding bearing brackets (3) so as to position the tank (1) in a predetermined position; and (iii) said projection (31) detaining the tank (1) on said bearing brackets (3) while said clamping element (15) is fastened and tightened.
